(19) United States
(12) Patent Application Publication
(10) Pub. No.: US 2018/0034122 A1
(43) Pub. Date: Feb. 1, 2018

(54) BATTERY THERMAL MANAGEMENT ASSEMBLY

(71) Applicant: NextEV USA, Inc., San Jose, CA (US)

(72) Inventor: Austin Newman, San Jose, CA (US)

(73) Assignee: NextEV USA, Inc., San Jose, CA (US)

(21) Appl. No.: 15/364,891

(22) Filed: Nov. 30, 2016

Related U.S. Application Data
(60) Provisional application No. 62/369,734, filed on Aug. 1, 2016.

(51) Int. Cl. H01M 10/6557; H01M 10/615; H01M 10/6551; H01M 10/613; H01M 10/625

(52) U.S. Cl. CPC H01M 10/6557; H01M 10/613; H01M 10/625; H01M 10/6551; H01M 10/615; H01M 2220/20

(57) ABSTRACT

A battery thermal management assembly is provided. The battery thermal management assembly includes a vehicle thermal assembly including a first thermal exchange module arranged adjacent to a first thermal exchange circuit. A battery pack includes a plurality of battery modules, a second thermal exchange circuit including heat transfer conduits contacting the plurality of battery modules, and a second thermal exchange module arranged adjacent to the second thermal exchange circuit. The second thermal exchange module is positioned facing the first thermal exchange module. The first thermal exchange circuit and the second thermal exchange circuit are isolated from each other. A thermal gap pad is arranged between the first thermal exchange module and the second thermal exchange module.

### INCORPORATION BY REFERENCE

This application claims priority under 35 U.S.C. §119 to U.S. Provisional Application No. 62/369,734, filed on Aug. 1, 2016, which is incorporated by reference herein in its entirety.

### FIELD OF INVENTION

The present disclosure relates to a battery, and more particularly relates to a thermal management assembly for a battery.

### BACKGROUND

Electric vehicles include battery packs to power a vehicle's electrical components, such as the motor, engine, control systems. Precise control systems are required for these battery packs to ensure that the battery assembly is maintained at an ideal temperature. Batteries perform optimally at particular charging temperatures, operating temperatures, and other characteristic temperature ranges. One known way to control the temperature of a vehicle's battery pack is to rely on the vehicle's central thermal management loop, which typically includes a radiator and a liquid/gas coolant in a thermal circuit. Electric vehicles can include interchangeable and rechargeable battery packs. These battery packs must be removed and re-installed by users as a charge level of a specific battery pack decreases or is depleted. It is time consuming and cumbersome for users to remove these battery packs due to a shared liquid/gas coolant connection with the vehicle's central thermal management loop. Due to the shared liquid/gas coolant connection, issues with leakage, aeration, and other performance and reliability issues occur during replacement of the battery pack.

It would be desirable to provide a battery pack for an electric vehicle that does not share a physical liquid/gas coolant connection with the vehicle's central thermal management loop, and it would also be desirable to provide an efficient thermal management arrangement for the vehicle's battery pack.

### SUMMARY

A battery thermal management assembly is provided. The battery thermal management assembly includes a vehicle thermal assembly including a first thermal exchange module arranged adjacent to a first thermal exchange circuit. A battery pack includes a plurality of battery modules, a second thermal exchange circuit including heat transfer conduits contacting the plurality of battery modules, and a second thermal exchange module arranged adjacent to the second thermal exchange circuit. The second thermal exchange module is positioned facing the first thermal exchange module. The first thermal exchange circuit and the second thermal exchange circuit are isolated from each other. A thermal gap pad is arranged between the first thermal exchange module and the second thermal exchange module. Based on this configuration, the thermal exchange circuit for the vehicle thermal assembly is isolated from the thermal exchange circuit of the battery pack.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1A is a schematic illustration of a battery thermal management assembly according to a first embodiment.

FIG. 1B is another schematic illustration of a battery thermal management assembly according to the first embodiment.

FIG. 2 is a schematic illustration of a battery thermal management assembly according to a second embodiment.

FIG. 3 is a schematic illustration of a battery thermal management assembly according to a third embodiment.

FIG. 4 is a schematic illustration of a battery thermal management assembly according to a fourth embodiment.

### DETAILED DESCRIPTION OF THE PREFERRED EMBODIMENTS

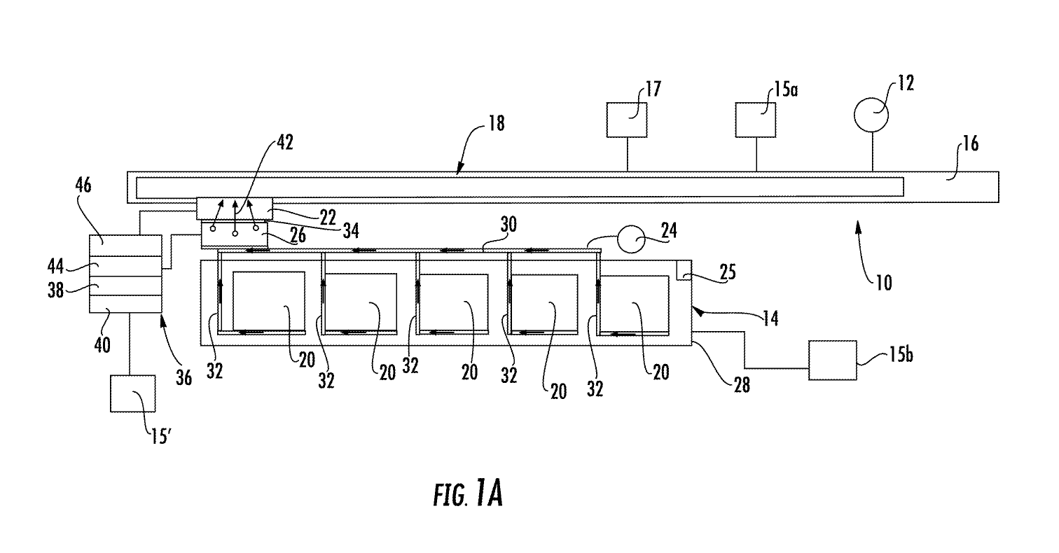

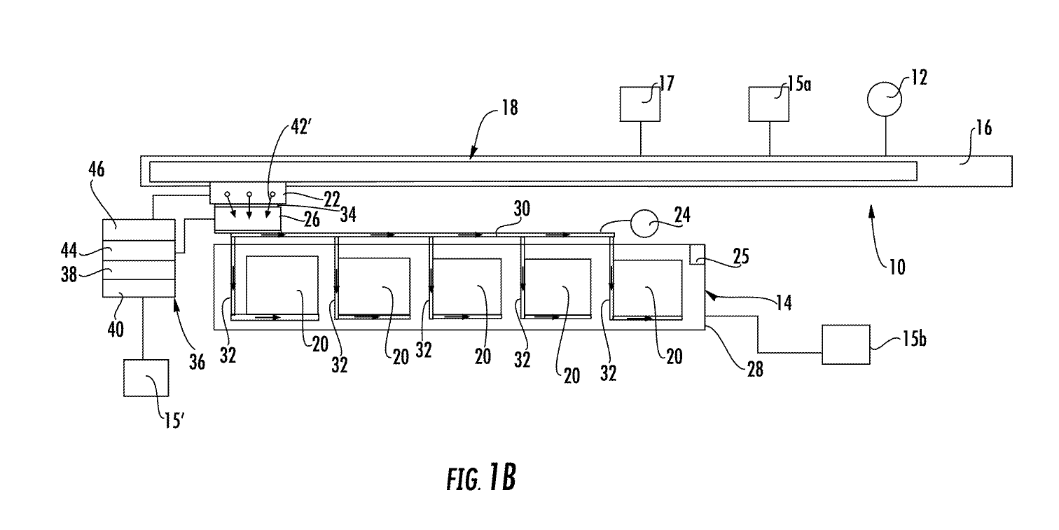

In one embodiment, a battery thermal management assembly 10 is illustrated in FIGS. 1A and 1B. As shown in FIGS. 1A and 1B, the battery thermal management assembly 10 includes a vehicle thermal assembly 18 and a battery pack 14.

The vehicle thermal assembly 18 is contained integrally within the vehicle, while the battery pack 14 is an easily and readily removable and interchangeable component. A user can quickly and reliably replace battery packs 14 as the existing battery pack 14 depletes its charge or otherwise must be replaced. A new, fully charged and functioning battery pack 14 can then be installed into the vehicle. As discussed above, replacing battery packs in known arrangements is unreliable, messy, cumbersome, and time-consuming because known arrangements include a battery pack integrated within the vehicle thermal assembly 18.

As shown in FIGS. 1A and 1B, the battery pack 14 is completely separated from the internal components of the vehicle thermal assembly 18, i.e. a coolant circuit, radiator, etc. The battery pack 14 and the vehicle thermal assembly 18 are completely separately positioned and arranged, and do not have a shared coolant connection. The vehicle thermal assembly 18 of FIGS. 1A and 1B includes a first thermal exchange module 22 positioned directly adjacent to a first thermal exchange circuit 19. FIGS. 1A and 1B illustrate a schematic view of a vehicle thermal assembly 18. One of ordinary skill in the art would recognize that the cooling and heating components of the vehicle thermal assembly 18 can be varied depending on a specific vehicle or application.

The vehicle thermal assembly 18 includes a first pump 12 for circulating coolant within the first thermal exchange circuit 19. The term coolant as used in this application includes any liquid, gas, or other medium that can be used to transfer heat. The vehicle thermal assembly 18 also includes a radiator 16. Although not specifically illustrated, the radiator 16 can include an evaporator, condenser, compressor, fan, blower, or any other known heating/cooling components. The term radiator can include any heat exchanger as understood by those of ordinary skill in the art.

The vehicle thermal assembly 18 is in communication with a plurality of vehicle components 15a, such as the motor, central controller, generator, converter, charger, etc. The plurality of vehicle components 15a are generically illustrated as a single box in FIGS. 1A and 1B, but those of ordinary skill in the art would recognize from the present disclosure that any number and variety of vehicle components can be arranged in communication with the vehicle thermal assembly 18. A first sensor 17 is also provided in communication with the first thermal exchange circuit 19 to monitor coolant within the first thermal exchange circuit 19. The radiator 16 is adjusted to control the heating or cooling of coolant within the first thermal exchange circuit 19 based on data from the first sensor 17. The first sensor 17 can detect a temperature of the coolant, flow rate of the coolant, and other characteristics of the coolant. Essentially, the vehicle thermal assembly 18 serves as a central heat transfer component for the entire vehicle.

The battery pack 14 is arranged adjacent to the vehicle thermal assembly 18. The battery pack 14 includes a plurality of battery modules 20 arranged within a housing 28. Each of the plurality of battery modules 20 is independently controlled and used to power the vehicle. A second thermal exchange circuit 30 includes heat transfer conduits 32 that contact each of the plurality of battery modules 20 to provide a heating or cooling effect. The housing 28 completely encloses the plurality of battery modules 20 and only partially encloses the second thermal exchange circuit 30.

The battery pack 14 is in electrical communication with the electrical components 15b of the vehicle, such as the motor, engine, electric control units, electric display units, electric power systems. The electrical components 15b are generically illustrated in FIG. 1A. A communication pathway can be established between the vehicle components 15a and the electrical components 15b.

The heat transfer conduits 32 can include heat transfer pipes or channels. The second thermal exchange circuit 30 is similar to the first thermal exchange circuit 19 and can include a second pump 24 for directing coolant within the second thermal exchange circuit 30. The first thermal exchange circuit 19 and the second thermal exchange circuit 30 are completely isolated from each other. The first thermal exchange circuit 19 and the second thermal exchange circuit 30 do not have any common coolant conduits and are completely separated from each other.

A second sensor 25 is also provided within the housing 28 for monitoring the coolant within the second thermal exchange circuit 30. The second sensor 25 functions similarly to the first sensor 17 described above. The battery pack 14 includes a second thermal exchange module 26 that is arranged directly facing the first thermal exchange module 22. The thermal exchange modules 22, 26 are aligned such that heat is transferred between the thermal exchange modules 22, 26.

The first and second thermal exchange modules 22, 26 provide the only heat exchange interface between the battery pack 14 and the vehicle thermal assembly 18. The first and second thermal exchange modules 22, 26 can include any electric/thermal component capable of heating or cooling. The first and second thermal exchange modules 22, 26 serve as a heat pump for the assembly 10. One known type of thermal exchange module includes a thermoelectric module. Known thermoelectric modules include a circuit comprising thermoelectric materials that generate electricity from heat directly, and/or can supply heat through the application of current or voltage. Therefore, the thermoelectric module can be used for heating and cooling, as well as power generation. In one embodiment, the thermoelectric module includes n-type and p-type doped semiconductor materials that are connected electrically in series and thermally in parallel. Typically, the semiconductor material and the thermoelectric materials are arranged between two ceramic substrates, which both provide mechanical structure as well as electrically insulating the elements within the thermoelectric module from each other and the external mounting surface. Any variety of substrate shape, substrate materials, thermoelectric material, internal components, mounting arrangement, and other characteristics can be varied for the first and second thermal exchange modules 22, 26.

The first and second thermal exchange modules 22, 26 bridge a thermal exchange gap between the battery pack 14 and the vehicle thermal assembly 18, such that the battery pack 14 can be heated or cooled. The battery pack 14 is heated if the battery pack 14 is below a certain temperature, or is cooled if the battery pack 14 is above a certain temperature. Each battery pack 14 has an ideal target operating temperature, ideal target charging temperature, etc. These temperatures are selected to ensure that the battery pack 14 is maintained at an optimal temperature. In one embodiment, a target temperature of the battery pack 14 is 70 degrees Fahrenheit. The target temperature can include a range, such as between 60-80 degrees Fahrenheit. The target temperature varies depending on the specifications of a particular battery pack.

A thermal gap pad 34 is arranged between the first thermal exchange module 22 and the second thermal exchange module 26. The thermal gap pad 34 is preferably arranged directly in contact with the first thermal exchange module 22 and the second thermal exchange module 26. The thermal gap pad 34 provides a heat transfer interface between the battery pack 14 and the vehicle thermal assembly 18. The material of the thermal gap pad 34 is selected to provide an effective thermal exchange interface. The thermal gap pad 34 may be comprised of an elastomer, silicone elastomer, or other suitable thermal gap material.

A thermoelectric control assembly 36 is also provided in communication with the first thermal exchange module 22 and the second thermal exchange module 26. The thermal exchange control unit 36 includes an electric control unit 38, a power supply unit 40, a thermoelectric control sensor 44, and a thermoelectric generator 46. The electric control unit 38 sends signals to the first thermal exchange module 22 and the second thermal exchange module 26 to either heat, cool, or absorb thermal energy. The power supply unit 40 is provided to supply power to the thermoelectric control assembly 36 and the first thermal exchange module 22 and the second thermal exchange module 26. The thermoelectric control sensor 44 detects the temperatures of the first thermal exchange module 22 and the second thermal exchange module 26. Collectively, the components of the thermoelectric control assembly 36 controls the functions of the first thermal exchange module 22 and the second thermal exchange module 26. The term “functions” refers to heating, cooling, absorbing heat, and/or converting heat into electrical energy or power. A second plurality of vehicle components 15′ can also be provided in communication with the thermoelectric control assembly 36. The thermoelectric control assembly 36 can provide power to the second plurality of vehicle components 15′ based on the absorbed thermal energy from the first thermal exchange module 22 and the second thermal exchange module 26. The second plurality of vehicle components 15′ are separately illustrated from the plurality of vehicle components 15a, but can include the same vehicle components.

A flow of coolant is illustrated in FIGS. 1A and 1B. In FIG. 1A, a first direction of coolant flow is indicated by a plurality of arrows in the second thermal transfer circuit 30. FIG. 1B illustrates an identical configuration as FIG. 1A, however the coolant flow is in a reverse direction compared to FIG. 1A. The control units and pumps regulate the flow direction, speed, volume, etc., of coolant. A first thermal flow 42 is illustrated in a first direction in FIG. 1A and a second thermal flow 42′ is illustrated in a second direction in FIG. 1B. The thermal flows 42, 42′ can be reversed depending on whether the battery pack 14 should be heated or cooled.

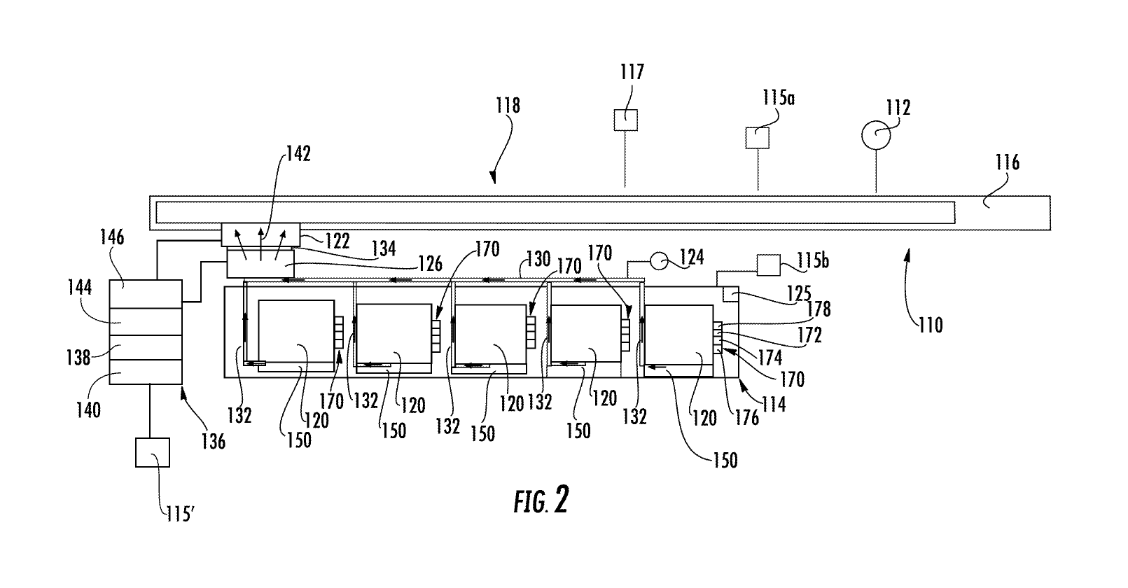

FIG. 2 illustrates a second embodiment of a battery thermal management assembly 110. The components not specifically discussed herein with respect to FIG. 2 are identical to FIGS. 1A and 1B except the reference numerals used in FIG. 2 are increased by 100. In FIG. 2, the battery pack 114 includes a plurality of supplemental thermal exchange modules 150. The supplemental thermal exchange modules 150 are each arranged adjacent to a respective one of the plurality of battery modules 120. Each of the plurality of battery modules 120 can include a secondary thermal exchange control unit 170, having a secondary electric control unit 172, a secondary power supply unit 174, a secondary thermoelectric control sensor 176, and a secondary thermoelectric generator 178. Each of the secondary thermal exchange control units 170 can be independently activated and controlled. The embodiment of FIG. 2 differs from the embodiment of FIGS. 1A and 1B in that each of the battery modules 120 includes its own thermal control assembly. In this embodiment, a targeted cooling or heating can occur for individual battery modules of the plurality of battery modules 120. Otherwise, the structure, function, and features of the vehicle thermal assembly 118 and the battery pack 114 of FIG. 2 are identical to the embodiment of FIGS. 1A and 1B.

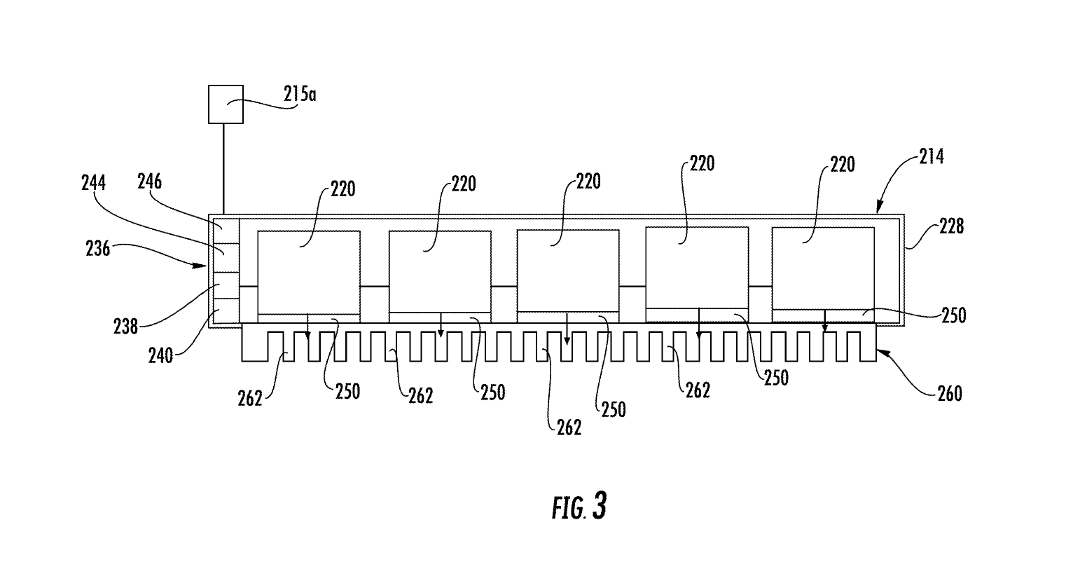

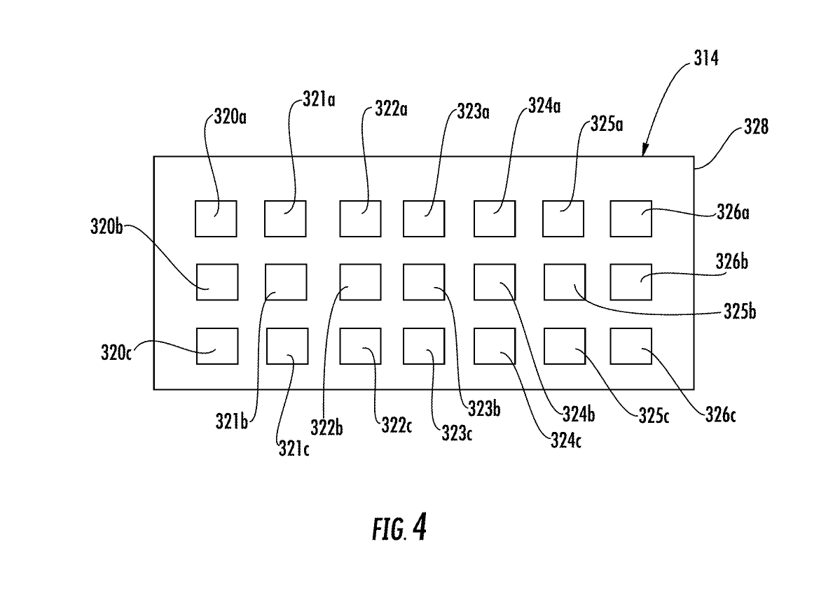

FIG. 3 illustrates a third embodiment of a battery pack 214. The components not specifically discussed herein with respect to FIG. 4 are identical to FIGS. 1A and 1B except the reference numerals used in FIG. 4 are increased by 200. The battery pack 214 includes a plurality of battery modules 220 and a plurality of thermal exchange modules 250 arranged within a common housing 218. Each one of the plurality of thermal exchange modules 250 is arranged adjacent to a respective one of the plurality of battery modules 220. A heat sink 260 is arranged adjacent to the housing 218. Preferably, the heat sink 260 is integrally formed with the housing 218. The heat sink 260 includes a plurality of fins 262 that project away from the battery pack 214 to promote thermal transfer away from the battery pack 214.

The battery pack 214 can include a plurality of individual thermal exchange control units, or a single common thermal exchange control unit. A simplified illustration is provided in FIG. 3 showing a thermal exchange control unit 236 including a secondary electric control unit 238, a secondary power supply unit 240, a secondary thermoelectric control sensor 244, and a secondary thermoelectric generator 246. The thermal exchange control unit 236 is connected to a plurality of vehicle components 215.

Although not specifically illustrated in FIG. 3, one of ordinary skill in the art would recognize that the battery pack 214 can include a thermal exchange circuit, similar to the thermal exchange circuit 30 of FIGS. 1A and 1B.

FIG. 4 illustrates a schematic representation of a fourth embodiment of a battery pack 314 having a housing 328 and a plurality of battery modules 320a-326a, 320b-326b, 320c-326c. The plurality of battery modules are arranged in rows that are spaced apart from each other. As shown in FIG. 4, the first row includes batteries 320a, 320b, 320c, the second row includes batteries 321a, 321b, 321c, etc. Each row can be independently controlled (i.e. heated, cooled) such that a temperature of the first row of batteries 320a, 320b, 320c can be varied from the last row of batteries 326a, 326b, 326c. In one embodiment, the front side of the housing 328 includes the first row of batteries 320a, 320b, 320c, and the rear end of the housing 328 includes the last row of batteries 326a, 326b, 326c. During operation, the front side of the housing 328 will encounter more ambient cooling air as the vehicle travels in the forward direction. Due to this ambient cooling air, the front row of batteries 320a, 320b, 320c will typically require less cooling and the back row of batteries 326a, 326b, 326c will typically require more cooling. The battery pack 314 can be selectively cooled such that the last row of batteries 326a, 326b, 326c are cooled more than the first row of batteries 320a, 320b, 320c.

The battery thermal management assembly of the present disclosure helps mitigate issues caused by a thermal runaway event. The thermal exchange modules can be used as a fire suppression element during thermal runaway events. In an overdrive mode, the thermal exchange modules can sustain increased temperature loads cause by thermal runaway, and allow an operator of a vehicle to bring the vehicle to a safe location before the thermal runaway inflicts serious damage on the vehicle.

Having thus described the presently preferred embodiments in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiments and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A battery thermal management assembly comprising:
a vehicle thermal assembly including a first thermal exchange module arranged adjacent to a first thermal exchange circuit; and
a battery pack including a plurality of battery modules, a second thermal exchange circuit including heat transfer conduits contacting the plurality of battery modules, and a second thermal exchange module arranged adjacent to the second thermal exchange circuit;
the second thermal exchange module is positioned facing the first thermal exchange module, the first thermal exchange circuit and the second thermal exchange circuit are isolated from each other, and a thermal gap pad is arranged between the first thermal exchange module and the second thermal exchange module.

2. The battery thermal management assembly of claim 1, wherein the battery pack lacks a shared connection with the first thermal exchange circuit, and coolant in the first thermal exchange circuit is isolated from the battery pack.

3. The battery thermal management assembly of claim 1, wherein the first thermal exchange circuit and the second thermal exchange circuit each include coolant.

4. The battery thermal management assembly of claim 1, wherein the vehicle thermal assembly further includes a radiator within the first thermal exchange circuit.

5. The battery thermal management assembly of claim 1, wherein the first thermal exchange module and the second thermal exchange module are each comprised of a thermoelectric module.

6. The battery thermal management assembly of claim 5, wherein each thermoelectric module is connected to a thermoelectric control assembly including a control unit, a power supply unit, a sensor, and a thermoelectric generator.

7. The battery thermal management assembly of claim 5, wherein each thermoelectric module is configured to heat, cool, or absorb heat and generate electricity.

8. The battery thermal management assembly of claim 1, wherein the battery pack includes a battery housing that encloses each of the plurality of battery modules, and the battery housing partially encloses the second thermal exchange circuit.

9. The battery thermal management assembly of claim 1, the battery pack further comprising a plurality of supplemental thermal exchange modules, each one of the plurality of supplemental thermal exchange modules is arranged adjacent to a respective one of the plurality of battery modules, and the plurality of supplemental thermal exchange modules are independently controlled and activated.

10. The battery thermal management assembly of claim 9, wherein the plurality of supplemental thermal exchange modules are each comprised of a thermoelectric module.

11. A battery thermal management assembly for a vehicle comprising:
a battery pack including a plurality of battery modules and a plurality of thermal exchange modules arranged within a housing, each one of the plurality of thermal exchange modules is arranged adjacent to a respective one of the plurality of battery modules; and
a heat sink arranged adjacent to the housing.

12. The battery thermal management assembly of claim 11, wherein the heat sink includes a plurality of fins that project away from the battery pack.

13. The battery thermal management assembly of claim 11, wherein the plurality of thermal exchange modules are independently controlled such that each one of the plurality of battery modules are selectively heated or cooled.

14. The battery thermal management assembly of claim 11, wherein the battery pack is isolated from a central vehicle thermal exchange circuit.
